(19) United States
(12) Patent Application Publication
(10) Pub. No.: US 2016/0307122 A1
(43) Pub. Date: Oct. 20, 2016

(54) DISCOVERING AND MAXIMIZING SOCIAL CONNECTIONS WITHIN A GEOGRAPHIC REGION FOR SELLING TO PATRONS OF SPORTS AND ENTERTAINMENT EVENTS

(71) Applicant: The Social Scene, LLC, Westborough, MA (US)

(72) Inventors: Frank A. Cincotta, Westborough, MA (US); Brian W. Schoenbeck, Newton, MA (US)

(21) Appl. No.: 15/098,386

(22) Filed: Apr. 14, 2016

Related U.S. Application Data
(60) Provisional application No. 62/147,830, filed on Apr. 15, 2015.

(51) Int. Cl. G06Q 10/02; G06Q 50/00; G06Q 30/02

(52) U.S. Cl. CPC G06Q 10/02; G06Q 30/0269; G06Q 50/01

(57) ABSTRACT

An automated process for capturing and storing patron information via both the event ticketing system and a one-time registration is described. A result set of the social connections is created for each and every event attendee. This result set can be produced on demand prior to the event and can be used to actively and directly sell and market to each social connection of the event attendees. A similar process can be used to identify the social connections in attendance at a sporting or entertainment event using the additional capture of ticket scans from the event ticketing system and targeting the social connections that have purchased and used a ticket for the event. This allows event promoters to provide a means for social connections to get together during sporting or entertainment events, either for free or for an additional fee.

### STATEMENT REGARDING FEDERALLY SPONSORED RESEARCH OR DEVELOPMENT

N/A

### BACKGROUND OF THE INVENTION

Various embodiments relate generally to event sales and marketing systems, methods, devices and computer programs and, more specifically, relate to combining event sales and marketing with event ticketing systems and social media.

This section is intended to provide a background or context. The description may include concepts that may be pursued, but have not necessarily been previously conceived or pursued. Unless indicated otherwise, what is described in this section is not deemed prior art to the description and claims and is not admitted to be prior art by inclusion in this section.

Attendance at sporting events and entertainment events are, in large part, a social activity enjoyed with family and friends. Sports teams and event promoters need a means of connecting event attendees with their friends and family, through the event attendee's social media connections.

Current approaches to this process are passive in nature and involve requiring the event attendee to share photos and/or post messages on social media in hopes that their social connections see the photos or messages. These actions usually occur during the sporting or entertainment event and are, therefore, not useful in the process of event promoters leveraging social connections for the purposes of increased ticket sales. Also, since the above approach requires event attendees to take action during an event in order for any potential social connections to be achieved, the participation rate for such requests is quite low, with no additional ticket sales achieved when the action occurs during the event.

What is needed is techniques to actively combine the event ticketing systems with social media.

### BRIEF SUMMARY OF THE INVENTION

The below summary is merely representative and non-limiting.

The above problems are overcome, and other advantages may be realized, by the use of the embodiments.

In a first aspect, an embodiment provides a method to create interest and awareness of events and for identifying and leveraging social connections of event patrons of said events in order to maximize attendance. The method includes receiving, from a ticketing server, ticketing information of an event. The ticketing information includes identification of at least one patron scheduled to attend the event. For each of the at least one patron, social connections which are connected to the patron are received from a social media provider. A social connection list is generated by creating a subset of the social connections based at least in part on the ticketing information and the social connections. The method also includes performing sales and marketing actions based on the social connection list. Generating the social connection list may include identifying social connections of the at least one patron scheduled to attend the event which are also scheduled to attend the event or identifying social connections of the at least one patron scheduled to attend the event which are not scheduled to attend the event.

In another aspect, an embodiment provides a computer readable medium to create interest and awareness of events and for identifying and leveraging social connections of event patrons of said events in order to maximize attendance. The computer readable medium is tangibly encoded with a computer program executable by a processor to perform actions. The actions include receiving, from a ticketing server, ticketing information of an event. The ticketing information includes identification of at least one patron scheduled to attend the event. For each of the at least one patron, social connections which are connected to the patron are received from a social media provider. A social connection list is generated from a subset of the social connections based at least in part on the ticketing information and the social connections. The actions also include performing sales and marketing actions based on the social connection list. Generating the social connection list may include identifying social connections of the at least one patron scheduled to attend the event which are also scheduled to attend the event or identifying social connections of the at least one patron scheduled to attend the event which are not scheduled to attend the event.

In a further aspect, an embodiment provides an apparatus (such as a computer server) to create interest and awareness of events and for identifying and leveraging social connections of event patrons of said events in order to maximize attendance. The apparatus includes a processor and a memory storing computer program code. The memory and the computer program code are configured to, with the processor, cause the apparatus to perform actions. The actions include to receive, from a ticketing server, ticketing information of an event. The ticketing information includes identification of at least one patron scheduled to attend the event. For each of the at least one patron, social connections which are connected to the patron are received from a social media provider. A social connection list is generated from a subset of the social connections based at least in part on the ticketing information and the social connections. The actions also include to perform sales and marketing actions based on the social connection list. Generating the social connection list may include identifying social connections of the at least one patron scheduled to attend the event which are also scheduled to attend the event or identifying social connections of the at least one patron scheduled to attend the event which are not scheduled to attend the event.

### BRIEF DESCRIPTION OF THE SEVERAL VIEWS OF THE DRAWINGS

Aspects of the described embodiments are more evident in the following description, when read in conjunction with the attached Figures.

FIG. 1 is a flow diagram of the data capture used in support of the pre-game processes in accordance with an embodiment.

FIG. 2 is a flow diagram of the data capture used in support of the in-game processes in accordance with an embodiment.

FIG. 3 is a screen shot of the summary view of the results of in-game social connection discovery process in accordance with an embodiment.

FIG. 4 is a screen shot of the detail view of the results of the in-game social connection discovery process in accordance with an embodiment.

FIG. 5 is a block diagram of components that are suitable for practicing various embodiments.

FIG. 6 shows a notification screen in accordance with an embodiment.

FIG. 7 shows a map screen in accordance with an embodiment.

FIG. 8 shows a logic flow diagram of a process to discover pre-event social media connections in accordance with an embodiment.

FIG. 9 shows a logic flow diagram of a process to discover in-event social media connections in accordance with an embodiment.

FIG. 10 is a logic flow diagram that illustrates the operation of a method, and a result of execution of computer program instructions embodied on a computer readable memory, in accordance with various embodiments.

### DETAILED DESCRIPTION OF THE INVENTION

This patent application claims priority from U.S. Provisional Patent Application No. 62/147,830, filed Apr. 15, 2015, the disclosure of which is incorporated by reference herein in its entirety.

Various embodiments provide systems and methods for creating interest and awareness of events in a defined geographic boundary and for identifying and leveraging social connections of event patrons of said events in order to maximize attendance. Such embodiments have the ability to capture patron and ticketing transactions from an event ticketing system, capture patron social connections from social media systems, correlate event ticket purchases to a specific patron, and produce an event-specific social connection map for each patron who has purchased a ticket to said event.

One non-limiting embodiment provides a system that includes six primary components, namely, (1) an aggregate data store, (2) a ticketing system integration service, (3) a social media integration service, (4) a social connection discovery process, (5) a smart phone app or web application, and (6) a client-facing web application.

The aggregate data store is the primary database server which is used for storing all data provided from all other components. The aggregate data store stores season ticket holder information, premium suite attendees' information, group attendees' information and complimentary ticket holder information which often times does not originate in the event ticketing system.

Data can be processed and stored in the aggregate data store, for example, when the ticketing system integration process acquires data from the event ticketing system, when the social medial process acquires information from social media providers, and/or when a patron enters their registration and demographic information into the smart phone application or web application. The social connection discovery process uses the data from the aggregate data store to produce the patron-specific, event-specific social connections and mappings used for both pre-game and in-game sales and marketing.

The geographic location of the patron can also be captured at the time of their registration in order to create an initial geographic boundary to be used when presenting events of potential interest. This boundary, known as geo-fencing, can be used throughout the app, in conjunction with the GPS capabilities of the smart phone, when determining a current location of the patron, and events within the current geographic boundary which may be of interest to the patron.

The smart phone or web application can be used by the patron to provide registration and demographic information. The provided information is stored in the aggregate data store and is used as the baseline for the patron profile. Any subsequent ticketing transactions provided through the ticketing system integration process are associated with the patron profile in the aggregate data store, further enhancing the patron profile.

In one non-limiting embodiment, a procedure to register a new fan is provided in the app. The user downloads the app from the app store. The user registers the app by providing their first name, last name and email address. A database search is performed to see if the user already exists in the database. If the user does not exist, their cell phone number and GPS location are captured from the smart phone and create a new user record in the database. The user is then prompted to connect to their social media accounts for the purpose of capturing their social connections and storing them in the app database.

Such a procedure may be as follows:

MAIN PROCEDURE REGISTER_FAN_APP

Prompt user for First name, Last name and email address
Lookup user email address in aggregate data store
IF email address does not already exist

Capture user's cell phone number and GPS location from
smart phone
Create a new Patron record in aggregate data store

ENDIF
Prompt user to login in to their social media account
Upon successful login
REPEAT

Call Procedure
LOAD_PATRON_SOCIAL_CONNECTION(Social Media
ID, Email Address)

UNTIL all user Social Media Connections are loaded into
aggregate data store

In the LOAD_PATRON_SOCIAL_CONNECTION procedure, when a new user registers the app, all their social connections are loaded into the database. The user's social media ID and email address, which are unique identifiers in the app, are used to correlate the user's social connections to the user in the database. The program creates a single entry in the database for each unique social connection a user has for the selected social media. For instance, for each social connection the user has in FaceBook, a corresponding record is created in the app database, associating the user with each record.

The LOAD_PATRON_SOCIAL_CONNECTION procedure may be as follows:

Procedure LOAD_PATRON_SOCIAL_CONNNECTION (Social Media
ID, Email Address)

Check the aggregate data store to see if the Social Media ID exists
for the selected Patron social connection
IF the Social Media ID exists for this Patron

Create a Social Connection record in the aggregate data store
that links the Patron record, including email address, to this
Social Media ID

ELSE IF the Social Media ID does not exist for this Patron

Check to see if the Email Address exists in the aggregate data
store
IF the Email Address exists

Associate the Social Media ID with the Email Address
for the current Patron record
Create a Social Connection record in the aggregate data
store that links the Patron record, including email
address, to this Social Media ID

ELSE IF the Email Address does not exist

Create a Social Connection record in the aggregate data
store that links the Patron record, including email
address, to this Social Media ID

ENDIF

ENDIF

Using a CONNECT_PATRON_TO_TEAM_OR_EVENT procedure creates a record that connects the user to a specific event or team in the database. This connection is then used to create additional interest and awareness of events, via the app, among all the user's social connections. The app sends a notification to all the user's social connections, within a prescribed geographic boundary. The notification contains event information as well as information regarding the social connections who are attending or interested in the event.

The CONNECT_PATRON_TO_TEAM_OR_EVENT procedure may be as follows:

Procedure CONNECT_PATRON_TO_TEAM_OR_EVENT
(Team_Event_ID)
IF Patron is not connected or following the Team_Event_ID

Create a record in aggregate data store to associate Patron with
Team_Event_ID
Create Patron record in the Team or Event-specific table to link
Patron with Team_Event_ID
Call Procedure Link_Patron_To_Team_Event( Patron_ID,
Team_Event_ID)

Search Team/Event-specific database for Social Media IDs that
match Patron IDs Social Media Connections
REPEAT

Create a Link Record in Team/Event-specific database
which links Patron_ID with Social Media ID

UNTIL all Patron_IDs Social Media Matches have been linked
in Team/Event-specific database

ENDIF

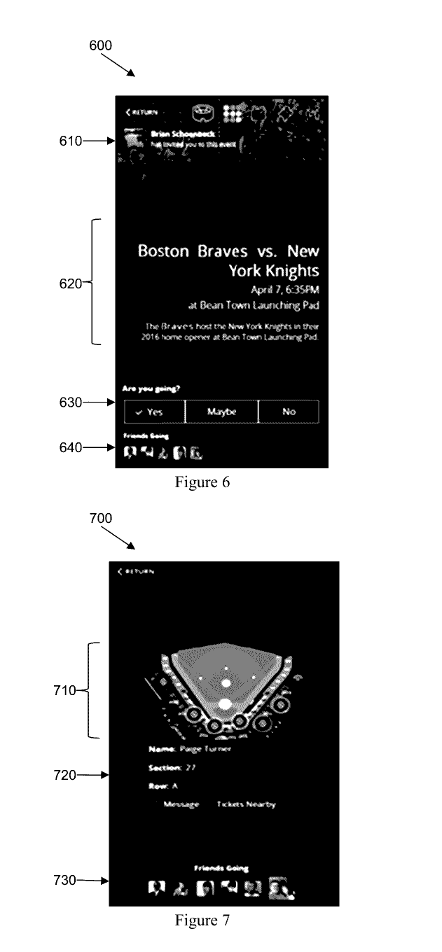

FIG. 6 shows a notification screen 600 in accordance with an embodiment. The screen 600 includes information 610 regarding who sent the notification, details 620 regarding the event and a series of response buttons 630, such as “Yes”, “No”, and “Maybe”. The screen 600 also provides a list 640 of contacts who are already planning to go to the event—presented here as a set of pictures.

When a user purchases a ticket for an event or otherwise indicates they will be going to the event, the system makes sure that user/patron is linked to the event. If patron is not already linked to the event a record of the patron is added to the database for the event (or team) using a LINK_PATRON_TO_TEAM_EVENT procedure. The LINK_PATRON_TO_TEAM_EVENT procedure may be as follows:

Procedure LINK_PATRON_TO_TEAM_EVENT (Patron_ID,
Team_Event_ID)

Search Team/Event-specific database for Patron ID
IF Patron ID does not exist

Create a Patron record in the Team/Event-specific database
for the current Patron

ENDIF

The ticketing system integration service is a ticketing system agnostic process which can be used to capture and process patron and event information provided by the source ticketing system. The patron and event information contain both patron demographic details and event ticketing details, such as number of tickets purchased and location and type of seats purchased. The ticketing system integration process also provides ticket scan information on the day of the event. This ticket scan information can become available and relevant when the patron is in attendance at the event.

A LOAD_TICKETING_SYSTEM_DATA procedure can be used to take the ticketing information (customer, event, date, seat, etc.) from the venue ticketing system and load it into the aggregate data store. This information is used to then create additional invitations to the event for social connections of the fan who purchased the ticket. This information can also be used to display the specific location in the venue where the patron will be sitting, enabling social connections to buy tickets in close proximity to the patron (see FIG. 7).

The LOAD_TICKETING_SYSTEM_DATA procedure may be as follows:

Main Procedure LOAD_TICKETING_SYSTEM_DATA
Establish a network connection to ticketing system
Request count of the number of new and updated patron and ticketing
records since the last
IF count > 0

Download the patron and ticketing records to aggregate data store
REPEAT

Call Procedure Load_Patron_Record
IF Patron has a ticketing transaction

Call Procedure Load_Patron_Tickets

ELSE

Move to next Patron record in record set

END

Until all patron and ticketing records are loaded

ELSE

No new records to load.
Wait until next interval

END

A LOAD_PATRON_RECORD procedure can capture the patron information from a ticketing transaction in the source ticketing system and load it into the aggregate data store. The associated patron information, in conjunction with the event, event type, event date, event venue and geographic location, can be used as a means of identifying patron interests and buying patterns for future marketing uses. The LOAD_PATRON_RECORD procedure may be as follows:

Procedure LOAD_PATRON_RECORD

IF the Patron already exists in the aggregate data store

Update the Patron information with the latest Patron
information provided by the ticketing system

ELSE

Create a new Patron record in the aggregate data store from
the information provided by the ticketing system

A LOAD_PATRON_TICKETS procedure is used to capture a ticketing transaction for a specific patron, from the source ticketing system, and load it into the aggregate data store. The associated ticket transaction information provides event, event date, event venue, geographic location, seating and patron details that can be used in several other areas to create invitations and other notifications to social connections of the patron who purchased the ticket. The LOAD_PATRON_TICKETS procedure may be as follows:

Procedure LOAD_PATRON_TICKETS

Create a new Patron Ticket record in the aggregate data store from
the information provided by the ticketing system

FIG. 7 shows a map screen 700 in accordance with an embodiment. Using the transaction information the system is able to provide a map 710 indicating where various social contacts going to the event are seated. The user can review specific details for the seating in the pop-out display 720. The map screen 700 also provides a list 730 of contacts going to the event—presented here as a set of pictures.

A PROMPT_PATRON_FOR_SOCIAL_REFERRALS procedure may be used to automatically prompt a patron to invite their social connections to an event for which the patron has already purchased tickets. This process creates awareness of and interest in said event with the patron's social connections. The PROMPT_PATRON_FOR_SOCIAL_REFERRALS procedure may be as follows:

Procedure PROMPT_PATRON_FOR_SOCIAL_REFERRALS

IF Patron has completed Event Ticket purchase

Lookup Patron Social connections to determine which ones do
not have a ticket to the selected event
Prompt the Patron with a listing of social connections to allow
the Patron to select the Social connections who are to receive
an Event Referral with a link to the Ticketing system

END

The social media integration service is used to harvest social media connections from social media providers such as Facebook, LinkedIn, Twitter, MySpace, Instagram, etc., for each patron in the aggregate data store. The resulting social media connections are stored in the aggregate data store. The social media integration service runs on a recurring interval basis in order to keep the social media connections updated for each patron in the aggregate data store. The social media integration service can also be used to capture contact information from patron address books and contact lists, such as smart phone contacts, Google Gmail contacts, MS Outlook contacts, and the like.

Using a LOAD_SOCIAL_MEDIA_CONNECTIONS procedure a series of records in the aggregate data store can be created that connects the patron and each of their social media connections for any and all social medium. This social connection record may be used for direct marketing via invitations and notifications to patron's social connections. The LOAD_SOCIAL_MEDIA_CONNECTIONS procedure may be as follows:

Main Procedure Load_Social_Media_Connections (Patron_ID)

Query Social Media Provider for a list of Social Connections for
Patron_ID
IF the number of Social Connections is > 0

REPEAT

Call Procedure Create_Patron_Social_Record
(Patron_ID, Social Media Connection ID, Social Media
Provider)

UNTIL all Social Connections for Patron_ID have been
processed from Social Media Provider

END

A CREATE_PATRON_SOCIAL_RECORD procedure is used to create a series of records in the aggregate data store for each social medium for which the patron has an account. For instance, if the patron has a Twitter, FaceBook and Instagram account, this procedure creates a record for each of the 3 accounts, linking the patron and their social media ID. The procedure may be as follows:

Procedure Create_Patron_Social_Record (Patron_ID, Social Media
Connection ID, Social Media Provider)
IF the Social Media Connection ID DOES NOT already exists for
Patron_ID and the Social Media Provider

Create a new Patron Social Connection record in the aggregate data
store for the Social Media Connection ID and Social Media Provider

ENDIF

The social connection discovery process is an event-specific process that is executed on demand by a user of the client-facing web application. To produce a pre-game listing of all social media connections for patrons of a specific event, the social connection discovery process queries the aggregate data store for ticketing and patron information for the event in question. Once it has produced a record set of patrons for the selected event, it queries the aggregate data store for social media connections for each patron of the selected event. For the purpose of discovering a list of social connections who are potential patrons for a selected event, the social connection discovery process then removes any social media connections, on a per-patron basis, who have purchased tickets to the selected event. The resulting record set is a list of social connections for every patron of the selected event who have not purchased tickets for the selected event. The resulting list can be used for direct and active sales and marketing to the discovered social connections of patrons to the selected event.

The social discovery process also produces a social grouping of all social connections for patrons who are attending a specific event. This grouping of social connections can be used for rearranging and regrouping patrons in order to attempt to seat them in contiguous seats at the selected event.

Another procedure used is one to iterate through the patrons of a specific event and determine which of their social connections have tickets and which ones do not. For the social connections who have a ticket to the same event, the patron and ticketing information can be used when displaying social connections in the event details of the app and in the seating map for the venue. For the social connections who do not have a ticket for the event, they can be sent an invitation of behalf of the patron, making them aware that the event is happening and inviting them to the event on behalf of the patron.

This procedure may be as follows:

Procedure Build_Pre-Game_Patron_Event_Social_Connection_List
(Event_ID)

Search Team/Event-specific ticketing information to find Patrons
who have purchased tickets to the selected Event_ID in the
Team/Event-specific database
REPEAT

Search Team/Event-specific database for Social Connections
of Patron ID

IF a Social Connection is found

Search Ticket records for Social Connection
IF Social Connection DOES NOT have a ticket to
Event_ID

/* The Recipient List entry contains both
Patron and Social Connection information for
the purpose of personalized messaging (text
message, email message, phone call, smart
phone app-based communication, etc.) to the
recipient
*/
Create a Recipient List entry containing First
Name, Last Name, Email Address, Social Media
ID, and Patron ID for the current Social
Connection of Patron ID

ENDIF

ENDIF

UNTIL all Social Connections for current Patron ID have been checked

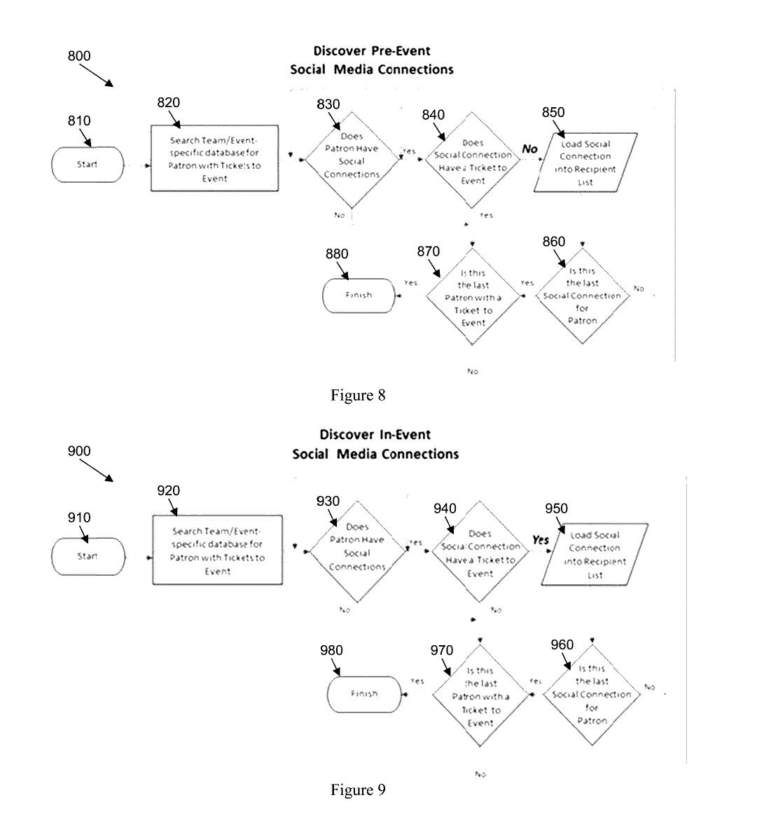

FIG. 8 shows a logic flow diagram 800 of a process to discover pre-event social media connections. A list of social media connections that are not yet going to the event is generated. The process begins at Block 810. A search is performed of the Team/Event specific database for patrons with tickets to the event at Block 820. At Block 830, a check is made to see if the patron has social connections. If the patron does have social connections, the process goes through each social connection and, at Block 840, checks to see if the social connection has tickets to the event. If the social connection doesn't have tickets, the social connection is loaded into a recipient list at Block 850. If the social connection has a ticket, the process proceeds directly to Block 860. At Block 860, the process determines whether the social connection is the last one for the patron, if not the process returns to Block 840 and the next social connection is checked.

Once the last social connection for the patron is checked, the process moves on to Block 870. Likewise, if the patron is determined to not have social connections in Block 830, the process moves on to Block 870. At Block 870, a check is made as to whether the patron is the last patron with a ticket to the event. If the patron is not the last patron, the next patron is checked at Block 830.

Once the last patron is checked, the process ends at Block 880.

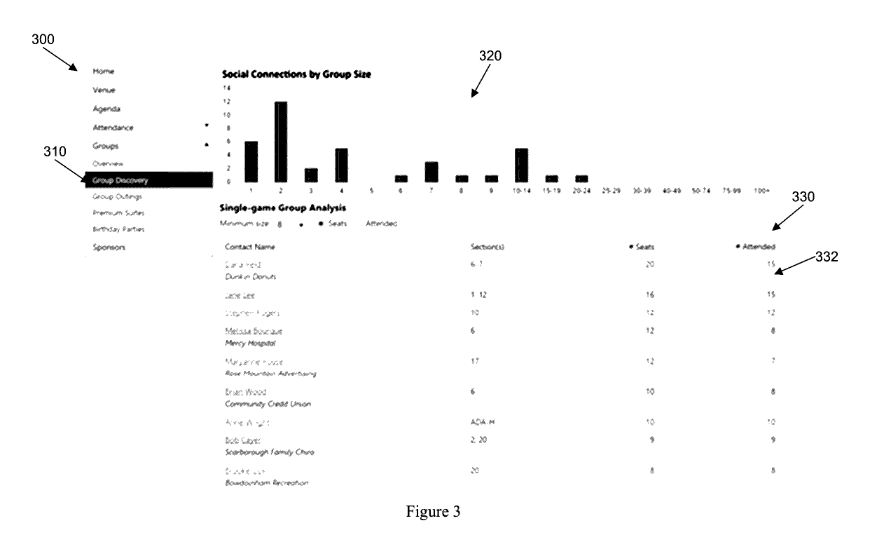

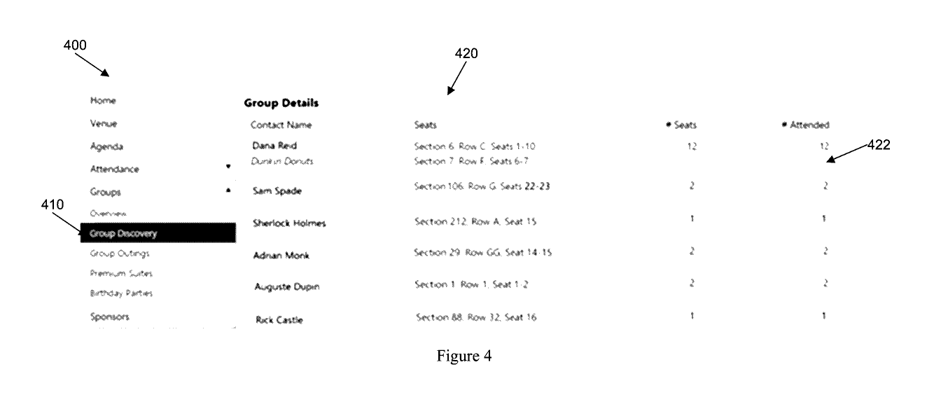

The social connection discovery process can also be used to produce an in-game listing of all social media connections for patrons who are in attendance at a selected event. The social connection discovery process utilizes the ticketing scan information previously stored in the aggregate data store to determine if a patron is in attendance. The resulting record set contains a listing of patrons and their social connections who are all attending the selected event at the same time. See FIG. 3 and FIG. 4.

FIG. 3 is a screen shot 300 of the summary view of the results of an in-game social connection discovery process in accordance with an embodiment. Using the group discovery menu item 310, the user is presented with a graph 320 showing social connections by group size. A single-game group analysis 330 is also presented. Each entry 332 provides details for contacts, such as name, business, section where their seats are located, number of seats, etc.

FIG. 4 is another screen shot 400 of the detail view of the results of the in-game social connection discovery process in accordance with an embodiment. Using the group discovery menu item 410, the user is presented with a group details table 420. Each entry 422 provides details for contacts, such as name, business, seats, total number of seats, etc.

A procedure may be used to determine the social connections of the patron who are attending the event. This information can be used by the venue or team proprietor to upsell or reseat the patron with their social connections. This procedure may be as follows:

Procedure Build_In-Game_Patron_Event_Social_Connection_List
(Event_ID)

Search Team/Event-specific ticketing information to find Patrons
who have purchased tickets to the selected Event_ID in the
Team/Event-specific database
REPEAT

Search Team/Event-specific database for Social Connections
of Patron ID
IF a Social Connection is found

Search Ticket records for Social Connection
IF Social Connection HAS PURCHASED a ticket to
Event_ID

/* The Recipient List entry needs to contain both
Patron and Social Connection information for the
purpose of personalized messaging (text message,
email message, phone call, smart phone app-based
communication, etc.) to the recipient
*/
Create an In-Game Recipient List entry containing
First Name, Last Name, Email Address, Social
Media ID, and Patron ID for the current Social
Connection of Patron ID

ENDIF

ENDIF

UNTIL all Social Connections for current Patron ID have been checked

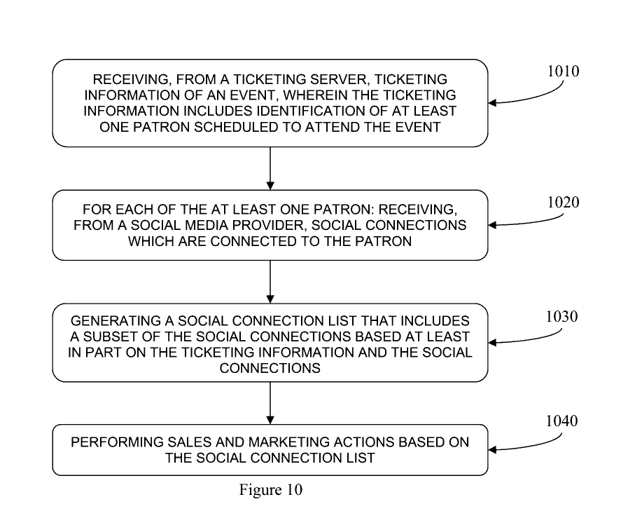

FIG. 9 shows a logic flow diagram 900 of a process to discover in-event social media connections. This process is similar to the one shown in FIG. 8 except that a list of social media connections which are going to the event is generated. The process begins at Block 910. A search is performed of the Team/Event specific database for patrons with tickets to the event at Block 920. At Block 930, a check is made to see if the patron has social connections. If the patron does have social connections, the process goes through each social connection and, at Block 940, checks to see if the social connection has tickets to the event. If the social connection has a ticket, the social connection is loaded into a recipient list at Block 950. If the social connection doesn't have tickets, the process proceeds directly to Block 960. At Block 960, the process determines whether the social connection is the last one for the patron, if not the process returns to Block 940 and the next social connection is checked.

Once the last social connection for the patron is checked, the process moves on to Block 970. Likewise, if the patron is determined to not have social connections in Block 930, the process moves on to Block 970. At Block 970, a check is made as to whether the patron is the last patron with a ticket to the event. If the patron is not the last patron, the next patron is checked at Block 930. Once the last patron is checked, the process ends at Block 980.

The client-facing web application is the user interface provided for launching the pre-game and in-game social connection discovery process, see FIG. 3 and FIG. 4.

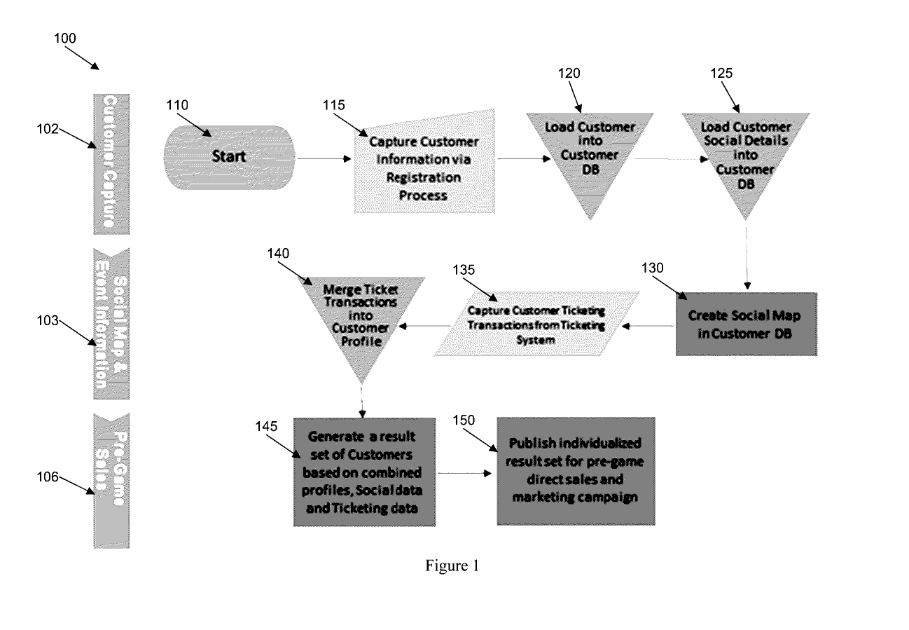

FIG. 1 is a flow diagram 100 of the data capture used in support of the pre-game processes in accordance with an embodiment. During a Customer Capture phase 102, the process beings on Block 110 and proceeds to capture customer information via a registration process in Block 115. Next, at Block 120, the customer is loaded into a customer database (DB) and the customer social details are added at Block 125.

A social map and event information phase 103 has a social map created in the customer DB at block 130. The social map is a representation of the interconnection of relationships in an online social network. Next the customer ticketing transactions are captured from the ticketing system at Block 135. Then the ticket transactions are merged into the customer profile at Block 140.

Block 145 begins the pre-game sales phase 106 by generating a result set of customers based on combined profiles, social data and ticketing data. The individualized result set is published for pre-game direct sales and marketing campaigns at Block 150.

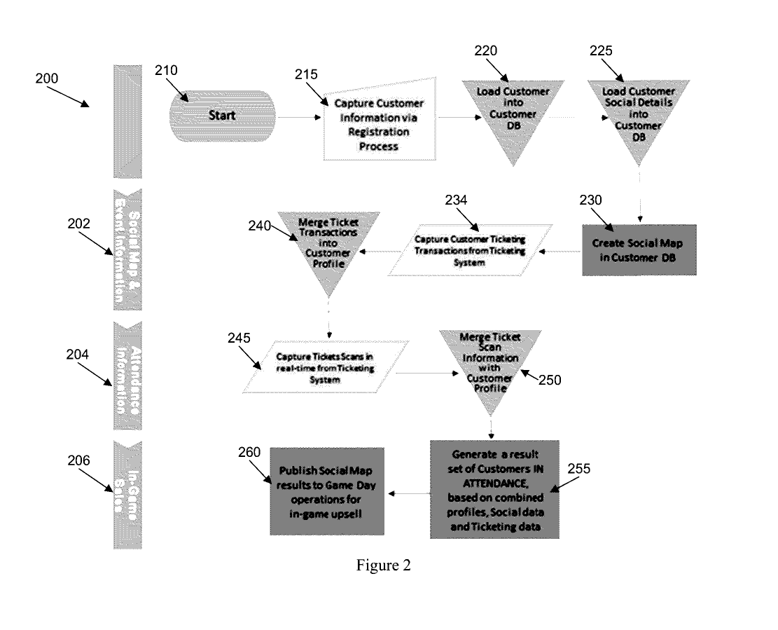

FIG. 2 is a flow diagram 200 of the data capture used in support of the in-game processes in accordance with an embodiment. The process begins at Block 210. Next, customer information is captured via a registration process at Block 215. At Block 220, the customer is loaded into a customer DB and, at Block 225, customer social details are loaded into the customer DB.

A social map and event information phase 202 begins at Block 230 when a social map is created in the customer DB. Customer ticketing transactions are captured from ticketing system at Block 235. At Block 240, ticket transactions are merged into the customer profile.

At Block 245, an attendance information phase 204 begins and ticket scans are captured in real-time from the ticketing system. The ticket scan information is merged with the customer profile at Block 250.

Beginning at Block 255, the in-game sales phase 206 starts when a result set of customers in attendance is generated based on the combined profiles, social data and ticketing data. Next, social map results are published to game day operations for in-game upsell at Block 260.

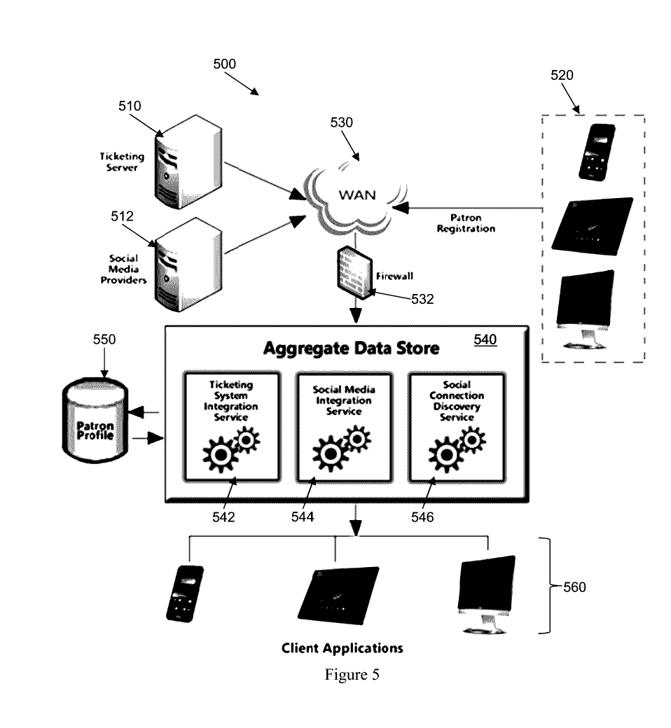

FIG. 5 is a block diagram of components that are suitable for practicing various embodiments. The system 500 shown enables combining event sales and marketing with event ticketing systems and social media. External services, such as the ticketing server 510 and social media providers 512 as well as patron devices 520 (e.g., smart phones, tablets, computers, etc.) are in communication through a wide area network (WAN) 530 (or the Internet) with the aggregate data store 540 via a firewall 532.

The aggregate data store 540 provides various services such as a ticketing system integration service 542, a social medial integration service 544 and a social connection discovery service 546. These services may be integrated into a single program or run as separate modules. The aggregate data store 540 is also configured to access a patron profile database (DB) 550.

Client applications 560 may communicate with the aggregate data store 540. Client applications 560 may be run on patron devices 520 and access the aggregate data store 540 through the WAN 530 and firewall 532.

In general, the devices shown in FIG. 5, such as ticketing server 510, social media providers 512, patron devices 520, etc. may include a controller, such as a data processor (DP), a computer-readable medium embodied as a memory that stores computer instructions, such as a program, and a suitable communication interface.

The programs may include program instructions that, when executed by the DP, enable the device to operate in accordance with an embodiment. That is, various embodiments may be carried out at least in part by computer software executable by the DP of the device, by hardware, or by a combination of software and hardware.

The memories may be of any type suitable to the local technical environment and may be implemented using any suitable data storage technology, such as magnetic memory devices, semiconductor based memory devices, flash memory, optical memory devices, fixed memory and removable memory. The DPs may be of any type suitable to the local technical environment, and may include general purpose computers, special purpose computers, microprocessors and multicore processors, as non-limiting examples.

In one, non-limiting embodiment, the system may be used to create a pre-event call list of event attendees and their social connections. The resulting call list can be used for direct sales and marketing to social connections for the purposes of generating additional ticket sales.

In another embodiment, the system may be used to create a pre-event email recipient list of event attendees and their social connections. The resulting recipient list can be used for creating bulk, personalized emails to the recipient list for the purposes of generating additional event ticket sales.

In a further embodiment, the system may be used to create personalized pre-event social media posts to social connections of event attendees for the purpose of generating additional event ticket sales.

In another embodiment, the system may be used to create personalized pre-event SMS messages to social connections of event attendees for the purpose of generating additional event ticket sales.

In a further embodiment, the system may be used to create an in-event attendee list of event attendees and their social interconnections. The resulting attendee list can be used for in-event upselling of social fan experiences and/or for upselling to a social group outing or social group seating.

In another embodiment, the system may be used to create an in-event attendee list of event attendees and their social interconnections for the purpose of sending in-event SMS messages to all event attendees and their social connections.

In a further embodiment, the system may be used to create an in-event attendee list of event attendees and their social interconnections for the purpose of augmenting their profile and preferences and direct selling and marketing to them for similar future events.

In another embodiment, the system may be used to create an in-event attendee list of event attendees and their social interconnections for the purpose of creating an in-event competition amongst event attendees and their social connections.

In a further embodiment, the system may be used to create an in-event attendee list of event attendees and their social interconnections for the purpose of targeting their social connections who are not present at the event in order to create social engagement, interest and reach beyond the event.

In another embodiment, the system may be used to rearrange event attendees with social connections so that they are all sitting in contiguous seats at the event. This process determines the to social connections who are attending a given event and provide them with available contiguous seating options within the venue in order to allow all social connections to sit together.

In a further embodiment, the system may be used to create an in-event attendee list of event attendees and their social interconnections for the purposes of displaying the social groups on the video board and generating additional interest for future events.

In another embodiment, the system may be used to create an in-event attendee list of event attendees and their social interconnections for the purpose of individual event competitions exclusive to social groups attending the event.

In a further embodiment, the system may be used to create an in-event attendee list of event attendees and their social interconnections for the purpose of season-long event competitions exclusive to social groups attending multiple events.

In another embodiment, the system may be used to provide a direct social referral capability to event attendees to invite their social connections to upcoming events. This process can be used at any point before the event takes place to maximum attendance at the event. The patron is prompted, via the smart phone app, to invite his social connections who do not already have a ticket to the event.

In a further embodiment, the system may be used to enable event attendees or potential event attendees to see which social connections have purchased tickets to an event. This process serves two purposes: first is to give the event attendee the opportunity to invite additional social connections who do not have a ticket to the event, and second is to leverage the ability to reseat all social connections in a contiguous block of seats for the event.

In another embodiment, the system may be used to enable potential event attendees to buy tickets next to their social connections. This process is accomplished by providing a view of current event attendees and their seating location for the event, prior to purchasing a ticket to the event. This enables the potential event attendee to select a seat within the ticketing system that is in close proximity to their social connection.

As described above, various embodiments provide a method, apparatus and computer program(s) to create interest and awareness of events in a defined geographic boundary and for identifying and leveraging social connections of event patrons of said events in order to maximize attendance.

FIG. 10 is a logic flow diagram that illustrates a method, and a result of execution of computer program instructions, in accordance with various embodiments. In accordance with an embodiment a method performs, at Block 1010, a step of receiving, from a ticketing server, ticketing information of an event. The ticketing information includes identification of at least one patron scheduled to attend the event. For each of the at least one patron, the method performs a step of receiving, from a social media provider, social connections which are connected to the patron at Block 1020. At Block 1030 the method performs a step of generating a social connection list described as a subset of the social connections. This social connection list is generated based at least in part on the ticketing information and the social connections. The method also performs a step of performing sales and marketing actions based on the social connection list at Block 1040.

The various blocks shown in FIGS. 1-2 and 8-10 may be viewed as method steps, as operations that result from use of computer program code, and/or as one or more logic circuit elements constructed to carry out the associated function(s).

An embodiment provides a method of providing a software application or mobile application to capture patron-specific demographic information, including social media account information, into a database.

In a further embodiment of the method above, a software application is used to harvest all social media connections for all registered patrons.

Another embodiment provides a method of using a software application to create a social media matrix (or social map) for all harvested social media connections.

A further embodiment provides a method of using a software application to capture event ticketing information and patron information for a given venue.

Another embodiment provides a method of using a software application to capture event ticketing system ticket scans and associate said scans to a specific patron.

A further embodiment provides a method of using a software application to merge event ticketing information with social media matrices to determine the intersection of event attendees and produce a result of social connections which have not purchases tickets for the event.

Another embodiment provides a method of using a software application to merge event ticketing information with social media matrices to determine the social connections of event attendees who are in attendance at a given event.

A further embodiment provides a method of using a software application to enable an event patron to view a list of their social connections and directly invite them, via social media, email, or SMS, to attend an upcoming event which the patron will be attending.

Another embodiment provides a method of using a software application to identify social connections who are all attending a specific event and attempt to seat the social connections in a contiguous block of seats.

A further embodiment provides a method of using a software application for de-anonymization of patrons.

Another embodiment provides a method of using a software application to enable patrons to see where there social connections are seated and enabling them to purchase tickets for contiguous seats.

A further embodiment provides a method of using a software application to enable patrons to see in real-time when their social connections arrive at an event, via ticket scanning and/or GPS.

Various operations described are purely exemplary and imply no particular order. Further, the operations can be used in any sequence when appropriate and can be partially used. With the above embodiments in mind, it should be understood that additional embodiments can employ various computer-implemented operations involving data transferred or stored in computer systems. These operations are those requiring physical manipulation of physical quantities. Usually, though not necessarily, these quantities take the form of electrical, magnetic, or optical signals capable of being stored, transferred, combined, compared, and otherwise manipulated.

Any of the operations described that form part of the presently disclosed embodiments may be useful machine operations. Various embodiments also relate to a device or an apparatus for performing these operations. The apparatus can be specially constructed for the required purpose, or the apparatus can be a general-purpose computer selectively activated or configured by a computer program stored in the computer. In particular, various general-purpose machines employing one or more processors coupled to one or more computer readable medium, described below, can be used with computer programs written in accordance with the teachings herein, or it may be more convenient to construct a more specialized apparatus to perform the required operations.

The procedures, processes, and/or modules described herein may be implemented in hardware, software, embodied as a computer-readable medium having program instructions, firmware, or a combination thereof. For example, the functions described herein may be performed by a processor executing program instructions out of a memory or other storage device.

The foregoing description has been directed to particular embodiments. However, other variations and modifications may be made to the described embodiments, with the attainment of some or all of their advantages. Modifications to the above-described systems and methods may be made without departing from the concepts disclosed herein. Accordingly, the invention should not be viewed as limited by the disclosed embodiments. Furthermore, various features of the described embodiments may be used without the corresponding use of other features. Thus, this description should be read as merely illustrative of various principles, and not in limitation of the invention.

What is claimed is:

1. A method comprising:
receiving, from a ticketing server, ticketing information of an event, wherein the ticketing information includes identification of at least one patron scheduled to attend the event;
for each of the at least one patron, receiving, from a social media provider, social connections which are connected to the patron;
generating a social connection list comprising a subset of the social connections based at least in part on the ticketing information and the social connections; and
performing sales and marketing actions based on the social connection list.

2. The method of claim 1, wherein the identification of at least one patron comprises contact information related to a purchased ticket to the event, and
the method further comprises, for each contact information, determining whether the contact information is associated with a patron and, in response to determining that the contact information is associated with a patron, identifying the patron as one of the at least one patron scheduled to attend the event.

3. The method of claim 2, wherein the contact information comprises at least one of: an email address, a telephone number, a patron identifier and a street address.

4. The method of claim 1, further comprising:
receiving a registration request from a first patron,
wherein receiving the social connections which are connected to the first patron is performed in response to receiving the registration request from the first patron.

5. The method of claim 1, wherein receiving the social connections which are connected to the first patron is performed repeatedly.

6. The method of claim 1, wherein generating the social connection list comprises identifying social connections of the at least one patron scheduled to attend the event which are also scheduled to attend the event.

7. The method of claim 6, wherein performing the sales and marketing actions comprises generating a map of seats at the event for a prospective purchaser based on the social connection list, wherein the prospective purchaser is one of the social connections and the map identifies seats associated with patrons connected to the prospective purchaser.

8. The method of claim 6, wherein performing the sales and marketing actions comprises identifying a block of seats sufficient to allow a patron and the social connections which are connected to the patron to sit together.

9. The method of claim 1, wherein generating the social connection list comprises identifying social connections of the at least one patron scheduled to attend the event which are not scheduled to attend the event.

10. The method of claim 9, wherein performing the sales and marketing actions comprises preparing an invitation to attend the event, wherein the invitation is prepared to be sent to the social connections which are not scheduled to attend the event and which are located within a prescribed geographic boundary.

11. The method of claim 10, wherein the invitation is one of: a short message service message, an email message, and a social media message.

12. A computer readable medium tangibly encoded with a computer program executable by a processor to perform actions comprising:
receiving, from a ticketing server, ticketing information of an event, wherein the ticketing information includes identification of at least one patron scheduled to attend the event;
for each of the at least one patron, receiving, from a social media provider, social connections which are connected to the patron;
generating a social connection list comprising a subset of the social connections based at least in part on the ticketing information and the social connections; and
performing sales and marketing actions based on the social connection list.

13. The computer readable medium of claim 12, wherein generating the social connection list comprises identifying social connections of the at least one patron scheduled to attend the event which are also scheduled to attend the event.

14. The computer readable medium of claim 13, wherein performing the sales and marketing actions comprises generating a map of seats at the event for a prospective purchaser based on the social connection list, wherein the prospective purchaser is one of the social connections and the map identifies seats associated with patrons connected to the prospective purchaser.

15. The computer readable medium of claim 13, wherein performing the sales and marketing actions comprises identifying a block of seats sufficient to allow a patron and the social connections which are connected to the patron to sit together.

16. The computer readable medium of claim 12, wherein generating the social connection list comprises identifying social connections of the at least one patron scheduled to attend the event which are not scheduled to attend the event.

17. The computer readable medium of claim 16, wherein performing the sales and marketing actions comprises preparing an invitation for the social connections to attend the event and which are located within a prescribed geographic boundary.

18. An apparatus, comprising at least one processor; and at least one memory including computer program code, the at least one memory and the computer program code configured to, with the at least one processor, cause the apparatus to perform at least the following:
to receive, from a ticketing server, ticketing information of an event, wherein the ticketing information includes identification of at least one patron scheduled to attend the event;
for each of the at least one patron, to receive, from a social media provider, social connections which are connected to the patron;
to generate a social connection list comprising a subset of the social connections based at least in part on the ticketing information and the social connections; and
to perform sales and marketing actions based on the social connection list.

19. The apparatus of claim 18, wherein generating the social connection list comprises identifying social connections of the at least one patron scheduled to attend the event which are also scheduled to attend the event.

20. The apparatus of claim 18, wherein generating the social connection list comprises identifying social connections of the at least one patron scheduled to attend the event which are not scheduled to attend the event.
